(19) United States
(12) Patent Application Publication
(10) Pub. No.: US 2026/0067544 A1
(43) Pub. Date: Mar. 5, 2026

(54) CONTENT GENERATION DEVICE, CONTENT GENERATION METHOD, PROGRAM, AND RECORDING MEDIUM

(71) Applicant: DWANGO Co., Ltd., Tokyo (JP)

(72) Inventors: Akihiko KOIZUKA, Tokyo (JP); Shinya KITAOKA, Tokyo (JP); Yushi NAKATANI, Tokyo (JP); Shunsuke YANAZAWA, Tokyo (JP)

(73) Assignee: DWANGO Co., Ltd., Tokyo (JP)

(21) Appl. No.: 19/108,263

(22) PCT Filed: Nov. 21, 2023
(86) PCT No.: PCT/JP2023/041773

§ 371 Date: Mar. 3, 2025

(30) Foreign Application Priority Data
Dec. 26, 2022 (JP) 2022-207873

(51) Int. Cl. H04N 21/81; G06T 13/20; G06T 13/40; G06T 13/80; G10L 13/027; H04N 21/234; H04N 21/478

(52) U.S. Cl. CPC H04N 21/8146; G06T 13/205; G06T 13/40; G06T 13/80; G10L 13/027; H04N 21/23424; H04N 21/478

(57) ABSTRACT

A distributor terminal includes an input unit that inputs a content that a distributor wants to distribute, a comment acquisition unit that acquires a comment given to a moving image to be distributed by a moving-image distribution server, a voice synthesis unit that generates a voice from the comment, a moving-image generation unit that generates a character content including a character or character data to perform an action according to the voice, and a moving-image synthesis unit that generates a moving image for distribution with the character content superimposed on the content.

### TECHNICAL FIELD

The present disclosure relates to a content generation device, a content generation method, a program, and a recording medium.

### BACKGROUND ART

Services capable of posting comments on distributed moving images are widely used (Patent Document 1). Each posted comment is displayed inside a display area of each moving image in a superimposed manner, or displayed in a comment section provided outside of the display area of the moving image. In live streaming in real time, that is, in a so-called live broadcast program, a viewer and a distributor can communicate with each other by the distributor reading out the comment posted by the viewer.

A technology for reading out comments with mechanical voices, rather than reading out the comments by the distributor himself or herself, is also used (Non-Patent Document 1).

In Patent Document 2, a technology for distributing an image with an avatar object as the incarnation of a user superimposed on an image shot by a user terminal device is disclosed.

### CITATION LIST

### Patent Documents

Patent Document 1: Japanese U.S. Pat. No. 6,295,494

Patent Document 2: Japanese Patent Application Laid-Open No. 2020-160645

### Non-Patent Document

Non-Patent Document 1: “BouyomiChan,” Internet <URL: https://chi.usamimi.info/Program/Application/BouyomiChan/>

### SUMMARY OF INVENTION

### Technical Problem

When a distributor himself or herself reads a comment aloud, the comment may be skipped over. There is a possibility that a viewer whose comment is skipped over will lose the desire to post a comment and stop watching the program. Skipping of the comment is resolved by reading out the comment with a mechanical voice using the technology of Non-Patent Document 1, but there is a problem that the viewer gets bored because of a monotonous synthesized voice.

The present disclosure has been made in view of the above, and it is an object thereof to generate a more attractive moving image for distribution.

### Solution to Problem

A content generation device according to one aspect of the present disclosure is a content generation device for generating a content to be distributed by a content distribution server, the content generation device including: an input unit that inputs the content; a comment acquisition unit that acquires a comment posted on the content distributed by the content distribution server; a voice synthesis unit that generates a voice from the comment; a generation unit that generates a character content including a character or character data to perform an action according to the voice; and a synthesis unit that generates a distribution content with the character content superimposed on the content.

### Advantageous Effects of Invention

According to the present disclosure, a more attractive moving image for distribution can be generated.

### BRIEF DESCRIPTION OF DRAWINGS

FIG. 1 is a diagram illustrating an example of the configuration of a moving-image distribution system of the present embodiment.

FIG. 2 is a diagram illustrating an example of the configuration of a distributor terminal.

FIG. 3 is a flowchart illustrating an example of a flow of processing of the distributor terminal.

FIG. 4 is a diagram illustrating an example of a screen generated by the distributor terminal.

### DESCRIPTION OF EMBODIMENTS

An embodiment of the present disclosure will be described below with reference to the accompanying drawings.

### System Configuration

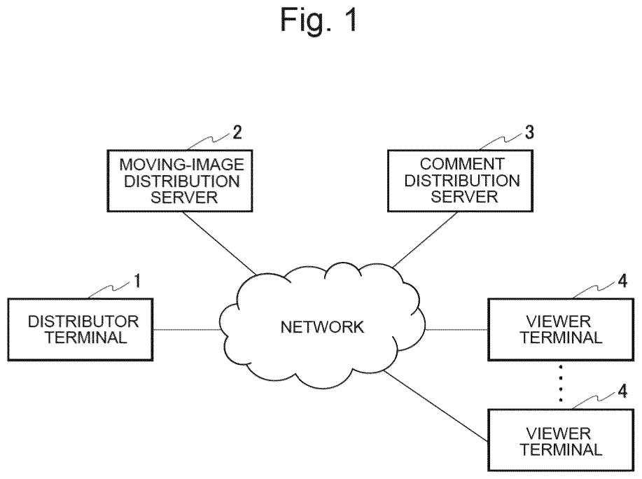

FIG. 1 is a diagram illustrating an example of the configuration of a moving-image distribution system of the present embodiment. The moving-image distribution system illustrated in this diagram includes a distributor terminal 1, a moving-image distribution server 2, a comment distribution server 3, and viewer terminals 4. Respective devices are connected communicably through a network. In FIG. 1, only two viewer terminals 4 are illustrated, but the present disclosure is not limited to this configuration. There are many viewers, and many viewer terminals 4 are connected. Further, only one distributor terminal 1 is illustrated, but there are actually many distributors, and many distributor terminals 1 are connected. Each viewer can select and watch a distributor's program that the viewer wants to watch.

The moving-image distribution server 2 distributes a moving image, received from the distributor terminal 1, to the viewer terminals 4 in real time. The distribution of the moving image in real time is also called live streaming, live broadcasting, or streaming. The moving-image distribution server 2 may accumulate moving images received from the distributor terminal 1 to deliver a moving image to a viewer terminal 4 at any time according to a distribution request from the viewer terminal 4. The delivery of the moving image at any time is also called time shifting.

The comment distribution server 3 receives a comment entered by the viewer on a moving image from the viewer terminal 4, and distributes the received comment in real time to viewer terminals 4 that receive the distribution of the same moving image. Information on the comment received from the viewer terminal 4 includes the content of the comment (character string), a user ID, and time information. The user ID is an identifier of the user who posted the comment. The time information is a time stamp of a program when the user posted the comment. The comment distribution server 3 may also deliver the comment to the distributor terminal 1. Further, the comment distribution server 3 receives a comment entered by a distributor from the distributor terminal 1, and delivers the comment to the viewer terminals 4 as a distributor comment.

The comment distribution server 3 manages and saves comments for each moving image. When receiving a distribution request from a viewer terminal 4, the moving-image distribution server 2 notifies the comment distribution server 3 of information that identifies the viewer terminal 4 and information that identifies the requested moving image. The comment distribution server 3 starts the transmission of the comment corresponding to the moving image to the viewer terminal 4 and the reception of a comment from the viewer terminal 4. The technology described in Patent Document 1 can be used for the distribution of the comment.

The viewer terminal 4 is a terminal used by a viewer who watches a program, and the viewer terminal 4 receives a moving image from the moving-image distribution server 2 and displays the moving image. When the viewer selects a live broadcast program (a moving image to be live broadcast) that the viewer wants to watch by operating the viewer terminal 4, the viewer terminal 4 transmits a moving-image distribution request to the moving-image distribution server 2. When receiving the distribution request, the moving-image distribution server 2 starts the transmission of the requested moving image to the viewer terminal 4. As the viewer terminal 4, for example, a personal computer (PC), a smartphone, or a tablet terminal can be used.

The viewer can post a comment on a live broadcast program while watching the live broadcast program. The viewer terminal 4 can display the comment posted on the live broadcast program. Specifically, when the viewer enters the comment on the viewer terminal 4, the viewer terminal 4 transmits the entered comment to the comment distribution server 3. The viewer terminal 4 delivers the posted comment to each of the distributor terminal 1 and the viewer terminal 4.

The viewer terminal 4 displays the delivered comment. The viewer terminal 4 may display the comment in a manner to be superimposed on the moving image, or may display the comment in a comment section outside of the display area of the moving image. The viewer can turn the display of the comment on or off by operating the viewer terminal.

The distributor terminal 1 is a terminal used by a distributor distributing a program to transmit, to the moving-image distribution server 2 in real time, a moving image that the distributor wants to distribute. For example, the distributor terminal 1 inputs a moving image shot with a camera connected to the distributor terminal 1, and transmits, to the moving-image distribution server 2, the input moving image with a character moving image to be described later superimposed thereon. The distributor terminal 1 may be equipped with the camera, or a video may be input from an external device such as a gaming device. As the distributor terminal 1, for example, a PC, a smartphone, or a tablet terminal can be used.

The distributor terminal 1 receives a comment on a live broadcast program from the comment distribution server 3 to generate a voice corresponding to the comment and generate a character moving image including a character performing an action corresponding to the comment. For example, the action corresponding to the comment is an action of lip-syncing the voice generated from the comment.

### Configuration of Distributor Terminal

Next, an example of the configuration of the distributor terminal 1 will be described.

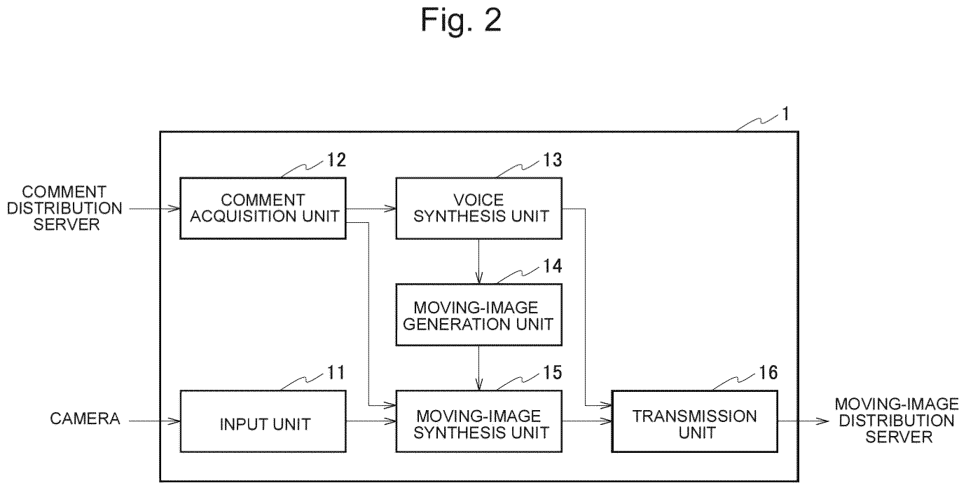

FIG. 2 is a diagram illustrating an example of the configuration of the distributor terminal 1. The distributor terminal 1 illustrated in this diagram includes an input unit 11, a comment acquisition unit 12, a voice synthesis unit 13, a moving-image generation unit 14, a moving-image synthesis unit 15, and a transmission unit 16. The respective units included in the distributor terminal 1 may consist of a computer equipped with an arithmetic processing unit, a storage device, and the like so that processing of each unit is executed by a program. This program is stored in the storage device equipped in the distributor terminal 1, where the program can also be recorded on a computer-readable non-transitory recording medium, such as a magnetic disk, an optical disk, or a semiconductor memory, or can be provided through a network.

The input unit 11 inputs a content that the distributor wants to distribute. For example, the content input by the input unit 11 is a moving image shot with the camera by the distributor himself or herself, a live moving image shot in advance, a computer graphics video drawn by the computer, the screen of an application (a game screen, painting software, a browser, or the like) executed on the distributor terminal 1 or any other device (a gaming device, a personal computer, a smartphone, a tablet terminal, or the like), or a still image such as a photo or an illustration. The details and format of the content do not matter as long as the content can be distributed by the moving-image distribution server 2. The input unit 11 may input and synthesize two or more contents. For example, when the distributor distributes a play moving image of a game, the input unit 11 generates a moving image obtained by synthesizing an image by shooting the distributor with the camera into a game screen input from a gaming device. In the following, contents including the content input by the input unit 11 and the content synthesized by the input unit 11 are called a content.

Note that the input unit 11 also inputs the sound of a content. When inputting sounds from two or more sources, the input unit 11 mixes these sounds. For example, when the distributor distributes a play moving image of a game, the input unit 11 mixes the sound of the game with the voice of the distributor. The sound of the game is input from the gaming device, and the voice of the distributor is input from a microphone connected to the distributor terminal 1.

The comment acquisition unit 12 acquires, from the comment distribution server 3, a comment posted by a viewer on a live broadcast program. As comments, there are a viewer comment posted by the viewer, a distributor comment input by the distributor, and a system comment displayed by the moving-image distribution system. In the following, it is assumed that, when simply calling it a comment, it refers to a viewer comment.

The voice synthesis unit 13 synthesizes (generates) a voice from the comment acquired by the comment acquisition unit 12. The voice synthesis unit 13 can use a general voice synthesis technology. For example, the voice synthesis unit 13 can use a voice synthesis technology from text to a voice using a deep learning technology.

The voice synthesis unit 13 synthesizes a voice from each comment in order of arrival of comments, and outputs the voice. When the output of the voice is finished, the voice synthesis unit 13 performs next comment processing.

When comments are posted in large numbers, the voice synthesis unit 13 may sort out comments to be read out (voices of which are generated), and read out only the out comments. For example, when comments are posted in large numbers, the voice synthesis unit 13 extracts a number of comments readable in time in order of arrival of comments, and generates voices only from the extracted comments. Comments that were not extracted are excluded from read-out targets. After that, when there is processing leeway, the voice synthesis unit 13 resumes reading out a newly posted comment(s).

As for a long comment, such as a comment with a large number of characters, the voice synthesis unit 13 performs voice synthesis so that the read-out time of the comment falls within a specific time. In other words, the voice synthesis unit 13 performs voice synthesis in such a manner that the long comment can be read aloud quickly.

The moving-image generation unit 14 generates a character moving image in which a character is lip-syncing from a voice synthesized by the voice synthesis unit 13. For example, the moving-image generation unit 14 generates the character lip-syncing based on phoneme information on the synthesized voice. The character moving image is a moving image in which the background part other than the character is transparent. The character may be a two-dimensional or three-dimensional character drawn with computer graphics, a hand drawn character, or a live action person. The character may also be an anthropomorphic animal or object other than a person.

The moving-image synthesis unit 15 generates a moving image for distribution by superimposing, on the content, the character moving image generated by the moving-image generation unit 14. The distributor can set the position of the character inside the moving image for distribution to any position. The distributor specifies the position and size of the character (the position of superimposing the character moving image) at the start of distribution. In the middle of distribution, the distributor may change the position and size of the character. When the content is a live-action moving image shot in real space, the moving-image synthesis unit 15 may arrange the character based on a real space coordinate system using an augmented reality (AR) technology.

The moving-image synthesis unit 15 may display the comment superimposed on the content, or may not display the comment inside the content. The moving-image synthesis unit 15 may superimpose and display the comment on the character moving image, or may superimpose and display the comment between the content and the character moving image. The display of the comment, the voice of the comment, and the movement of the character can be synchronized by superimposing the comment over the moving image on the distributor terminal 1. Note that even if the comment is not superimposed over the content on the distributor terminal 1, the viewer terminal 4 can acquire the comment from the comment distribution server 3 to superimpose and display the comment on the distributed moving image.

The moving-image synthesis unit 15 superimposes the character moving image on the content, and mixes the voice generated by the voice synthesis unit 13 and the sound of the moving image for distribution.

The transmission unit 16 transmits, to the moving-image distribution server 2, the moving image for distribution.

### Operation of Distributor Terminal

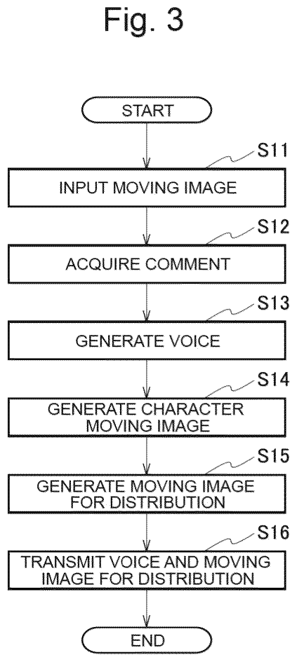

Referring to a flowchart in FIG. 3, an example of a flow of processing of the distributor terminal 1 will be described. The following processing is performed repeatedly from when the distributor starts distributing a live broadcast program until the distribution ends.

In step S11, the distributor terminal 1 inputs a content that the distributor wants to distribute.

In step S12, the distributor terminal 1 acquires a comment posted by a viewer from the comment distribution server 3.

In step S13, the distributor terminal 1 generates a voice from the comment acquired in step S12.

In step S14, the distributor terminal 1 generates a character moving image from the voice generated in step S13.

Note that the process in step S11 and the process in step S12 or step S14 may be performed in parallel.

In step S15, the distributor terminal 1 superimposes the character moving image generated in step S14 on the content input in step S11 to generate the moving image for distribution.

In step S16, the distributor terminal 1 transmits, to the moving-image distribution server 2, the voice generated in step S13 and the moving image for distribution generated in step S15.

The moving-image distribution server 2 distributes, to each of the viewer terminals 4, the moving image for distribution. The comment distribution server 3 receives, from each of the viewer terminals 4, a comment posted by each viewer, and distributes the comment to the distributor terminal 1 and each of the viewer terminals 4.

### Example of Moving Image for Distribution

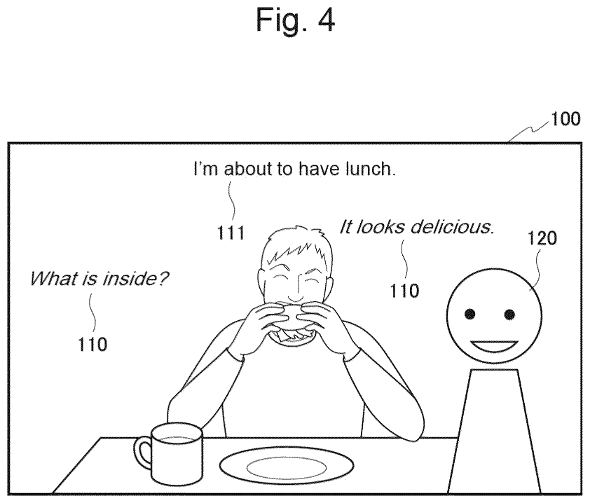

Referring to FIG. 4, an example of the screen of a moving image for distribution will be described. FIG. 4 is a diagram illustrating an example of a screen generated by the distributor terminal. On a screen 100 illustrated in FIG. 4, comments 110 and 111, and a character 120 are superimposed on a moving image shot with the camera.

The comments 110 are viewer comments posted by a viewer. For example, the viewer's comments move from the right edge to the left edge of the screen. The comment 111 is a distributor comment input by the distributor. The distributor comment 111 is displayed at the top of the screen. Although not illustrated, a system comment is displayed at the bottom of the screen 100.

The character 120 lips-syncs according to voices generated from the comments 110 and 111. Thus, a live broadcast program can be broadcast as if the character 120 is reading the comments aloud. When the distributor responds to viewer comments, since it looks like the distributor responds to the character 120 reading the comments aloud, more attractive two-way communication can be achieved between the distributor and the viewer.

### Modifications

Next, some modifications of the present embodiment will be described.

The voice synthesis unit 13 may also perform voice synthesis on comments with voice qualities different for each type of comment. For example, the voice synthesis unit 13 may synthesize the voices of the viewer comment, the distributor comment, and the system comment with different voice qualities, or may synthesize them in such a manner that only the system comment is read out aloud with a different voice quality. The voice synthesis unit 13 may also learn the voices in such a manner that the voices can be synthesized with distributor's voice to perform voice synthesis on the distributor comment with the distributor's voice quality. The moving-image generation unit 14 may also generate character moving images of characters different in voice quality. For example, the moving-image generation unit 14 may vary between a character to read the viewer comments aloud and a character to read the distributor comment aloud.

The voice synthesis unit 13 may perform voice synthesis on a comment with a different voice quality for each commented user. For example, the voice synthesis unit 13 uses a voice synthesis model capable of outputting multiple types of voice qualities (about dozen types). When performing voice synthesis on comments, the voice synthesis unit 13 stores each user ID and an identification number of each voice quality in association with each other. When the association between the user ID and the identification number of the voice quality is stored, the voice synthesis unit 13 performs voice synthesis on each comment with the associated voice quality. When the association between the user ID and the identification number of the voice quality is not stored, that is, in the case of a comment from a new user, the voice synthesis unit 13 associates the user ID with an identification number of any of voice qualities to perform voice synthesis on the comment with the voice quality. When the number of commented users is more than the number of voice qualities, the same voice quality may be associated with two or more users. The moving-image generation unit 14 prepares a character corresponding to each of voice qualities to generate a character moving image in which the character corresponding to the quality of a voice synthesized by the voice synthesis unit 13 is lip-syncing.

The viewer may also specify at least either a character reading the viewer's comment aloud or the voice quality. For example, the viewer specifies a character and a voice quality with a command when posting a comment. The voice synthesis unit 13 may change the voice quality depending on the display mode (color, size, display position) of the comment. In this case, the viewer can specify a character and a voice quality depending on the display mode of the comment.

Characters corresponding to the number of commented users may be displayed. For example, when comments are posted at the same time or at close times, the voice synthesis unit 13 performs voice synthesis on the comments in such a manner that the voices overlap with one another, rather than to perform voice synthesis on the comments in order, and outputs the comments so that the moving-image generation unit 14 displays two or more characters at the same time.

The moving-image generation unit 14 may make a character perform an action based on the content of a comment. For example, when the content of the comment is “8888” (a character string in which two or more 8 are consecutive, which means applause in Japan), the moving-image generation unit 14 generates a character moving image in which the character claps hands. At this time, the voice synthesis unit 13 may not output a voice corresponding to “8888,” may output clapping sound, or may synthesize a clapping voice to be uttered. When the content of a comment is “www” (a character string in which one or more w are consecutive, which means laughter in Japan), the moving-image generation unit 14 generates a character moving image in which a character laughs. When the character “w” is given to the end of the comment, the moving-image generation unit 14 generates a character moving image in which a character laughs after reading the comment aloud.

The moving-image generation unit 14 may also make the character perform an action according to the comment posting status (for example, the amount of comments). For example, when a large amount of comments have arrived, the moving-image generation unit 14 generates a character moving image in which a character makes a panic move. When there are few comments, for example, when no comments have arrived within a specified time or more, the moving-image generation unit 14 generates a character moving image in which the character do something that seems boring.

In a case where a gift can be given to a live broadcast program, when the gift is given, the moving-image generation unit 14 may generate a character moving image in which a character do something to be grateful for the gift. The voice synthesis unit 13 may synthesize a voice for reading out the name of a user who has given the gift. Further, the moving-image generation unit 14 may generate a character moving image to perform an action according to the performance of the gift given. For example, when the performance is that an object is made to fall from the top edge of the screen, the moving-image generation unit 14 generates a character moving image to perform an action to catch the falling object.

While the distributor is speaking, reading out of any comment may be stopped temporarily. For example, while distributor's voice is input into the microphone, the voice synthesis unit 13 temporarily stops input of any comment, and does not perform voice synthesis on the comment. When detecting the end of distributor's speaking, the voice synthesis unit 13 may resume temporarily stopped reading out of the comment from the position where reading out is interrupted, or the comment may be read out from the beginning. Comments acquired during distributor's speaking, the comments may be excluded from read-out targets. Alternatively, the voice synthesis unit 13 may temporality hold the comments acquired during distributor's speaking to perform voice synthesis on the comments sequentially after the distributor's speaking.

The distributor terminal 1 may also transmit character data (for example, motion data and the like) for generating a character moving image. Specifically, the moving-image generation unit 14 generates character data from a synthesized voice, and the moving-image synthesis unit 15 superimposes the character data on the content, and the transmission unit 16 transmits the content with the character data superimposed thereon. In this case, the viewer terminal 4 generates a character moving image from the character data, superimposes the character moving image on the content, and displays the content. The moving-image distribution server 2 may also generate the character moving image, superimpose the character moving image on the content, and transmit, to the viewer terminal 4, the content with the character moving image superimposed thereon. The distributor terminal 1 may transmit the content and the character data separately.

Note that in the present embodiment, the character moving image is generated on the distributor terminal 1, but the character moving image may be generated on the viewer terminal 4, and superimposed and displayed on a moving image to be distributed. Specifically, the viewer terminal 4 synthesizes voices from comments acquired from the comment distribution server 3, generates a character moving image from the synthesized voice, superimposes the character moving image on a moving image received from the moving-image distribution server 2, displays the superimposed moving image, and outputs the synthesized voice. Similarly as for a time-shifted moving image, when the character moving image is generated on the viewer terminal 4, a character reading a posted comment aloud is displayed by performing voice synthesis on the comment and making the character moving image so that the moving image can be watched.

As described above, the distributor terminal 1 of the present embodiment includes the input unit 11 that inputs a content that the distributor wants to distribute, the comment acquisition unit 12 that acquires a comment posted on a moving image distributed by the moving-image distribution server 2, the voice synthesis unit 13 that generates a voice from the comment, the moving-image generation unit 14 that generates a character moving image including a character to perform an action according to the voice, and the moving-image synthesis unit 15 that generates a moving image for distribution with the character moving image superimposed on the content. Thus, since a moving image in which the character reads a comment(s) aloud can be distributed, posting of a comment can be motivated. The distributor replies to a viewer comment to be able to distribute such a moving image that it is like the distributor is having a dialogue with the character.

### REFERENCE CHARACTERS

1: distributor terminal
11: input unit
12: comment acquisition unit
13: voice synthesis unit
14: moving-image generation unit
15: moving-image synthesis unit
16: transmission unit
2: moving-image distribution server
3: comment distribution server
4: viewer terminal

1. A content generation device for generating a content to be distributed by a content distribution server, comprising:
an input unit that inputs the content;
a comment acquisition unit that acquires a comment posted on the content distributed by the content distribution server;
a voice synthesis unit that generates a voice from the comment;
a generation unit that generates a character content including a character or character data to perform an action according to the voice; and
a synthesis unit that generates a distribution content with the character content superimposed on the content.

2. The content generation device according to claim 1, wherein
the voice synthesis unit generates a voice with a voice quality different for each type of comment or each comment poster, and
the generation unit generates the character content including a character corresponding to the voice quality or data on the character.

3. The content generation device according to claim 2, wherein at least either of the voice quality and the character is specified by the poster of the comment.

4. The content generation device according to claim 1, wherein the generation unit generates the character content including a character or character data to perform an action according to the content of the comment.

5. The content generation device according to claim 4, wherein when the content of the comment includes a character string in which a plurality of 8 numbers are consecutive, the generation unit generates the character content including a character or character data to perform an action to clap hands.

6. The content generation device according to claim 1, wherein the generation unit generates the character content including a character or character data to perform an action according to the comment posting status.

7. The content generation device according to claim 1, wherein the voice synthesis unit temporarily stops generating any voice while a distributor is speaking.

8. The content generation device according to claim 1, wherein the voice synthesis unit generates a voice with a tempo according to the content and length of the comment.

9. A content generation method for a content generation device to generate a content to be distributed by a content distribution server, the content generation method comprising:
inputting the content;
acquiring a comment posted on the content distributed by the content distribution server;
generating a voice from the comment;
generating a character content including a character or character data to perform an action according to the voice; and
generating a distribution content with the character content superimposed on the content.

10. (canceled)

11. A non-transitory computer-readable medium that stores a program which, when executed, causes a computer to act as a content generation device for generating a content to be distributed by a content distribution server, the program causes the computer to execute:
inputting the content;
acquiring a comment posted on the content distributed by the content distribution server;
generating a voice from the comment;
generating a character content including a character or character data to perform an action according to the voice; and
generating a distribution content with the character content superimposed on the content.
